(19) United States
(12) Patent Application Publication
(10) Pub. No.: US 2008/0286546 A1
(43) Pub. Date: Nov. 20, 2008

(54) Continuous glassy carbon composite materials reinforced with carbon nanotubes and methods of manufacturing same

(75) Inventors: David S. Lashmore, Lebanon, NH (US); Peter L. Antoinette, Nashua, NH (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: NanoComp Technologies, Inc.

(21) Appl. No.: 11/715,756

(22) Filed: Mar. 8, 2007

Related U.S. Application Data
(63) Continuation-in-part of application No. 11/415,927, filed on May 2, 2006.
(60) Provisional application No. 60/677,116, filed on May 3, 2005.
(60) Provisional application No. 60/760,748, filed on Jan. 20, 2006.

(51) Int. Cl. B32B 1/08; B32B 5/02; B32B 27/00; B01J 21/18; B29C 47/88

(52) U.S. Cl. 428/220; 428/367; 428/292.1; 428/293.7; 502/185; 502/184; 502/182; 264/211.12

(57) ABSTRACT

A method for manufacturing a carbon composite is provided. The method includes providing a carbon-containing resin material having an appropriate concentration of catalyst particles. Thereafter, the resin material may be extruded through an aperture while being exposed to a high temperature range to permit polymerization of the extruded resin material. A subsequent exposure of the extruded resin material to another elevated temperature range causes carbon in the resin material to couple to the catalyst particles to promote carbon nanotube growth and transformation of the resin material to a reinforced composite material. Reinforced composite materials are also provided.

### RELATED US APPLICATION(S)

The present application is a continuation-in-part of U.S. application Ser. No. 11/415,927, filed May 2, 2006, which application claims priority to U.S. Provisional Patent Application Ser. Nos. 60/677,116, filed May 3, 2005 and 60/760,748, filed Jan. 20, 2006. These applications are all hereby incorporated herein by reference.

### TECHNICAL FIELD

The present invention relates to carbon composites having a relatively high loading of carbon nanotubes and methods of manufacturing same, and more particularly, to continuous glassy carbon composites reinforced with carbon nanotubes.

### BACKGROUND ART

Carbon nanotubes are known to have extraordinary tensile strength, including high strain to failure and relatively high tensile modulus. Carbon nanotubes may also be highly resistant to fatigue, radiation damage, and heat. To this end, the addition of carbon nanotubes to composites can increase tensile strength and stiffness. Examples of composites that have incorporated nanotubes include epoxy-nanotube, Krayton-nanotube, PEEK (polyaryletherketone)-nanotube, phenyl formaldehyde-nanotube, RESOL-nanotube, furfuryl alcohol-nanotube, pitch-nanotube, latex-nanotube, polyethylene-nanotube, polyamide-nanotube, or carbon-carbon (nanotube) composites.

Unfortunately adding even a small amount of carbon nanotubes to, for instance, a resin matrix to subsequently generate the desired composite can increase the viscosity of the matrix significantly. As a result, a maximum of only between 1% to 5% by weight of carbon nanotubes may be added to a resin using current mixing technology.

Moreover, continuous carbon nanotubes are not yet readily available, so as to permit the creation of a substantially continuous carbon nanotube composite, or a substantially continuous composite reinforced with the continuous carbon nanotubes. The availability of either or both composites can allow for a variety of interesting commercial applications.

Accordingly, it would be advantageous to provide a substantially continuous composite material reinforced with substantially continuous carbon nanotubes, such that the composite material can be provided with a low density while having high modulus and strength. In addition, it would be advantageous to provide a method for manufacturing such composite materials.

### SUMMARY OF THE INVENTION

The present invention, in one embodiment, is directed to a composite material, and in particular, a substantially continuous glassy carbon monofilament. The glassy carbon filament, in accordance with an embodiment, includes a glassy carbon matrix extending along the length of the filament and within which at least one substantially continuous carbon nanotube is situated along the length of the filament. The amount of nanotube within the glassy carbon matrix can range from about less than 1% by volume to about 70% by volume.

In another embodiment of the present invention, a substantially continuous glassy carbon sheet is provided. The glassy carbon sheet, in an embodiment, includes a film of a glassy carbon matrix along the exterior the sheet and within which a plurality of carbon nanotubes may be situated along the length of the sheet. The amount of carbon nanotubes within the film of glassy carbon matrix can range from about less than 1% by volume to about 70% by volume.

The present invention also provides a method for manufacturing a glassy carbon filament reinforced with at least one carbon nanotube. The method includes initially providing a resin material, for instance, a liquid resin material having a carbon source and a catalyst for forming a carbon nanotube. Examples of suitable resins for use in the present method include high-carbon-containing resins with a glassy-carbon precursor, such as RESOL resin (i.e., catalyzed alkyl-phenyl formaldehyde), furfuryl alcohol, PVA, or other similar resins with a glassy carbon precursor. Resins with a non-glassy carbon precursor may also be used. An example of such a resin is pitch. Examples of a catalyst include a magnetic transition metal, a compound of a magnetic transition metal, noble metals, ceramic and intermetallic particles, and fullerenes, such as C₆₀, among others. Next, the resin material may be catalyzed in the presence of elevated temperatures. Thereafter, the catalyzed resin material can be extruded through a heated opening that can approximate the shape of the filament, so that as the filament flows through the heated opening, the resin material may be polymerized (i.e., cross-linked). The filament may thereafter be pyrolyzed to permit growth of carbon nanotubes from the catalysts within filament. In an embodiment, the extrusion can be carried out in a pressurized environment.

The present invention further provides a method for manufacturing a glassy carbon sheet reinforced with a plurality of carbon nanotubes. The method includes initially providing a resin material, for instance, a liquid resin material having a carbon source and a catalyst for forming a carbon nanotube. Examples of suitable resins for use in the present method include high-carbon-containing resins with a glassy-carbon precursor, such as RESOL resin (i.e., catalyzed alkyl-phenyl formaldehyde), furfuryl alcohol, PVA, or other similar resins with a glassy carbon precursor. Resins with a non-glassy carbon precursor may also be used. An example of such a resin is pitch. Examples of a catalyst include a magnetic transition metal, a compound of a magnetic transition metal, noble metals, ceramic and intermetallic particles, and fullerenes, such as C₆₀ among others. Next, the resin material may be catalyzed in the presence of elevated temperatures. Thereafter, the catalyzed resin material can extruded through a heated slot that can approximate the shape of the sheet, so that as the resin material flows through the heated opening, the resin material may be polymerized (i.e., cross-linked). The extruded sheet may thereafter be pyrolyzed to permit growth of carbon nanotubes from the catalysts within the resin material to reinforce the sheet. In an embodiment, the extrusion can be carried out in a pressurized environment.

### BRIEF DESCRIPTION OF DRAWINGS

FIG. 1A illustrates a cross-sectional view of a continuous monofilament of the present invention.

FIG. 1B illustrates various components used in the manufacture of the monofilament shown in FIG. 1A.

FIG. 2A illustrates a continuous glassy carbon sheet manufactured in accordance with another embodiment of the present invention.

FIG. 2B illustrates various components used in the manufacture of the sheet shown in FIG. 2A.

### DESCRIPTION OF SPECIFIC EMBODIMENTS

The present invention provides continuous monofilaments fibers and continuous sheets of glassy carbon reinforced with carbon nanotubes, for example, single wall carbon nanotubes (SWNT) and/or multi-wall carbon nanotubes (MWNT).

### Continuous Monofilament

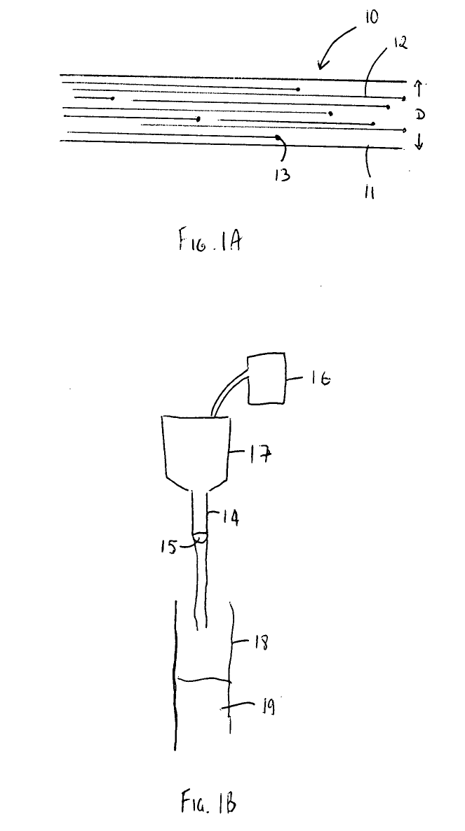

The present invention provides, as illustrated in FIG. 1A, a composite material, and in particular, a substantially continuous monofilament 10 (referred to hereinafter as either filament or monofilament). The filament 10, in accordance with an embodiment, includes a glassy carbon matrix 11 extending substantially along the length of filament 10, and may have a diameter D that is less than about 10 microns, and preferably less than about 2 microns. The filament 10 may also include at least one substantially continuous carbon nanotube 12 situated within the glassy carbon matrix 11 and along the length of the filament 10.

In an embodiment, the carbon nanotube 12 may include a catalyst particle 13 at an end of the nanotube 12. The catalyst particle 13, as it should be appreciated, can act as a template from which the carbon nanotube 12 grows during the manufacturing process of the monofilament 10. Examples of such a catalyst particle 13 include a magnetic transition metal, a compound of a magnetic transition metal, noble metals, ceramic and/or intermetallic particles, and fullerenes, such as C₆₀, among others. In addition, the amount of carbon nanotubes 12 within the glassy carbon matrix 11 can range from about less than 1% by volume to about 70% by volume. In an embodiment, the amount of carbon nanotubes 12 within the glassy carbon matrix 11 may be about 50% by volume.

### Process of Manufacture (Continuous Filament)

The process by which the monofilament 10 may be made includes, in general, catalyzing a resin material, for instance, a liquid resin material, having a glassy carbon precursor and a catalyst. In an embodiment, the resin material may be high-carbon-containing resins having a glassy-carbon precursor, such as RESOL resin (i.e., catalyzed alkyl-phenyl formaldehyde), furfuryl alcohol, PVA, or other similar resins with a glassy carbon precursor. Resins with a non-glassy carbon precursor may also be used. An example of a resin having a non-glassy carbon precursor is pitch.

As for the catalyst, suitable catalysts may be nanoscale in size and may include at least one of ferrocene; iron nano-particles; iron pentacarbonyl; nano-particles of magnetic transition metals or a compound of magnetic transition metals, such as iron, cobalt, cobalt hexacarbonyl, nickel, nickel hexacarbonyl, molybdenum or their alloys, or oxides, nitrates or chlorides of these metals or any combination of the oxides or other reducible salts (e.g., iron ammonium sulfate or iron chloride) or organometallic compounds of these metals; noble metals, such as gold; ceramic and intermetallic particles; other catalysts known to form carbon nanotubes, such as fullerenes, for instance C₆₀, or small portions of carbon nanotubes; or a combination of any of these. In an embodiment, the catalyst includes a mixture of fullerene (dissolved in toluene), ferrocene, and thiophene. To the extent that gold may be used as a catalyst, the gold particles, in an embodiment may be provided with a diameter in a range of from about 1 nm to about 10 nm.

In an embodiment, the catalyst particles may be added at an appropriate concentration to the carbon-containing resin, so as to provide the resulting composite material with optimal properties. To that end, the concentration of the catalyst or catalyst precursor used in connection with the present invention may be a function of concentration of carbon in the resin. In an example where ferrocene (Fe(C₅H₅)₂) is added to high-carbon-containing RESOL phenyl formaldehyde, the concentration of ferrocene may range from about 0.005 percent to about 5 percent by weight. More particularly, the ratio of ferrocene may be about 2 percent by weight (iron to carbon). Alternatively, the catalyst particles may be substantially uniformly dispersed throughout the resin to provide an appropriate concentration.

Referring now to FIG. 1B, to generate the continuous filament 10 of the present invention, a nozzle 14 having an opening or aperture 15 may initially be provided through which the resin material may be directed. The aperture 15, in an embodiment, may be provided with a diameter ranging from about 0.5 microns to about 500 microns. Moreover, as it should be appreciated, the aperture 15 may be designed to approximate a desired cross-sectional shape of an extruded continuous filament 10. To that end, the aperture 15 can be of any geometric shape that permit a substantially uniform stream of the resin material to extrude. However, a separated flow geometry may be desirable.

To facilitate the extrusion of the resin material through the aperture 15 in the nozzle 14, the nozzle 14, in an embodiment, may be in communication with a pressure source 16. The pressure source 16, in one embodiment, can be coupled to a chamber 17 within which the resin material may be located prior to extrusion through the nozzle 14. Alternatively, a hydraulic cylinder, for example, may be utilized so as to bear on the resin material and thereby forcing the resin material through the nozzle 14. In accordance with an embodiment, the chamber 17 or cylinder may be heated to a temperature below that at which the resin material starts to cross link. For example, for furfuryl alcohol, the threshold temperature is about 50° centigrade (C). However, the nozzle 14 can be independently heated to help cross link the resin material as rapidly as possible as it moves across the aperture 15.

As the extruded filament 10 of resin material exits through the aperture 15 of the nozzle 14, the filament 10 of resin material may, in accordance with one embodiment, be subjected to additional heat to further promote evaporation of any solvents, and to substantially complete cross linking. This post heating, in an embodiment, can be accomplished by passing the extruded filament 10 though a radiation heater 18 having temperatures not exceeding about 300° C., and preferably below 200° C. The now substantially dried and substantially fully polymerized filament 10 may have a diameter, at this stage, that can be substantially similar to or less than the diameter of the aperture 15 in the nozzle 14.

The extruding filament 10 may next be subjected to a pyrolysis process whereby the filament 10 may be exposed to a slow and gradual increase in heat, for instance, less than 1° C. per minute, in an inert atmosphere 19, such as Argon or Helium, free of oxygen, or in a vacuum. In an embodiment, the temperature may be raised to at least between about 1000° C. and about 2000° C., and more preferably about 1500° C. to about 1700° C. This slow increase in temperature, in one embodiment, allows the catalyst to act as a template to which carbon within the high-carbon-containing resin can attach. The attachment of carbon to the template catalyst and the subsequent attachment to the existing carbon on the template catalyst (i.e., particle) occurs in series, so as to lead to the growth of a substantially continuous nanotube within the substantially continuous filament 10. To the extent that there may be a plurality of catalyst particles, the formation of an array of substantially continuous carbon nanotubes can be attained within the continuous filament 10. The result can be the formation of a composite material having a glassy carbon matrix reinforced by a “grown-in” continuous carbon nanotube or an array of continuous carbon nanotubes. In an embodiment, the process can generate a substantially aligned array nanotubes.

To the extent necessary, the activity of the catalyst (e.g., iron particles) may need to be augmented. In one embodiment of the invention, thiophene (C₄H₄S) or another sulfur containing compound, for example, may be added to the resin prior to or during pyrolysis to augment the activity of the catalyst. In addition, it may be desirable to add trace amount of, for instance, Nb, Mo, Cr, or a combination thereof to the resin prior to or during pyrolysis to refine the size of the catalyst particles, in order to control the size of the nanotubes being grown.

Moreover, if desired, the glassy carbon filament 10 may be exposed to a final ramp temperature in excess of about 2500° C. to anneal the filament 10 to remove any potential defects within the filament 10.

It should be noted that during extrusion, any known means of applying a pressure can be used, including pneumatic pressure or oil pressure. This pressure, in an embodiment, should be applied in such a manner, so as to cause a substantially uniform displacement such that the diameter of the filament 10 is substantially uniform. In one embodiment, this can be done by the use of, for example, hydraulic proportional valves, which can obtain a reference to the position through such means as a capacitance probe, an LVDA, or an induction sensor etc.

### Continuous Sheet

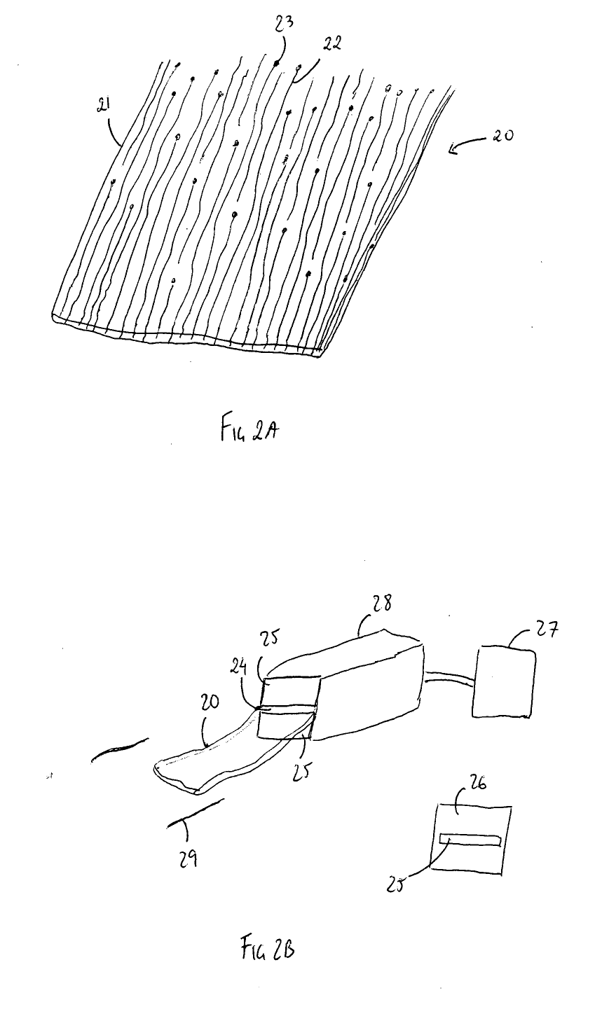

The present invention also provides, as illustrated in FIG. 2A, a substantially continuous sheet 20. The sheet 20, in accordance with an embodiment, includes a film of a glassy carbon matrix 21 extending substantially along the length of sheet 20. The sheet 20 may also include an array of continuous carbon nanotubes 22 situated within the glassy carbon matrix 21 and extending along the length of the sheet 20. In an embodiment, the array of carbon nanotubes 22 may include a catalyst particle 23 at an end of each nanotube 22. Examples of such a catalyst particle 23 include a magnetic transition metal, a compound of a magnetic transition metal, noble metals, ceramic and/or intermetallic particles, and fullerenes, such as C₆₀, among others. In addition, the amount of carbon nanotubes 22 within the glassy carbon matrix 21 can range from about less than 1% by volume to about 70% by volume. In an embodiment, the amount of carbon nanotubes 22 within the glassy carbon matrix 21 may be about 50% by volume. The sheet 20, as illustrated in FIG. 2A, may be provided with a thickness less than about 10 microns, and preferably less than about 2 microns.

### Process of Manufacture (Continuous Sheet)

The process by which the sheet 20 may be made, in general, may be similar to that utilized in the manufacture of filament 10. In particular, the process involves catalyzing a resin material having a glassy carbon precursor and a catalyst. In an embodiment, the resin material may be high-carbon-containing resins having a glassy-carbon precursor, such as RESOL resin (i.e., catalyzed alkyl-phenyl formaldehyde), furfuryl alcohol, PVA, or other similar resins with a glassy carbon precursor. Resins with a non-glassy carbon precursor may also be used. An example of a resin having a non-glassy carbon precursor is pitch. As for the catalyst, suitable catalysts may be nanoscale in size and may include at least one of ferrocene; iron nano-particles; iron pentacarbonyl; nano-particles of magnetic transition metals or a compound of magnetic transition metals, such as iron, cobalt, cobalt hexacarbonyl, nickel, nickel hexacarbonyl, molybdenum or their alloys, or oxides, nitrates or chlorides of these metals or any combination of the oxides or other reducible salts (e.g., iron ammonium sulfate or iron chloride) or organometallic compounds of these metals; noble metals, such as gold; ceramic and intermetallic particles; other catalysts known to form carbon nanotubes, such as fullerenes, for instance C₆₀, or small portions of carbon nanotubes; or a combination of any of these. In an embodiment, the catalyst includes a mixture of fullerene (dissolved in toluene), ferrocene, and thiophene. To the extent that gold may be used as a catalyst, the gold particles, in an embodiment may be provided with a diameter in a range of from about 1 nm to about 10 nm.

The catalyst particles, in an embodiment, may be added at an appropriate concentration to the carbon-containing resin, so as to provide the resulting composite material with optimal properties. To that end, the concentration of the catalyst or catalyst precursor used in connection with the present invention may be a function of concentration of carbon in the resin. In an example where ferrocene (Fe(C₅H₅)₂) is added to high-carbon-containing RESOL phenyl formaldehyde, the concentration of ferrocene may range from about 0.005 percent to about 5 percent by weight. More particularly, the ratio of ferrocene may be about 2 percent by weight (iron to carbon). Alternatively, the catalyst particles may be substantially uniformly dispersed throughout the resin to provide an appropriate concentration.

Looking now to FIG. 2B, to generate the continuous sheet 20, a slot 24 approximating a shape of sheet 20 may initially be provided through the resin material may be directed. The slot 24, in an embodiment, may be formed from two adjacently placed plates 25. These plates 25 may be made from, for example, hardened stainless steel, silicon carbon, or any material capable of being chemically non-reactive with the resin material or oxygen, while capable of withstanding elevated temperatures and pressures. In one embodiment, these plates 25 may be ground or polished to provide an substantially smooth extruded sheet 20. Moreover, one or both of the plates 25 may be adjustable relative to the other plate, so as to permit control of the thickness of the extruded sheet 20. In an embodiment, the plates may be adjustable to provide an extruded sheet 20 having a thickness in range of from about 0.5 microns to about 500 microns. In an alternate embodiment, instead of plates 25, a single plate 26 may be used. Such a plate may be provided with a fixed size slot 24. When using plate 26 with a fixed size slot 24, a plurality of plates 26 may be provided, each with different sized slot 24 for extruding a different sized continuous sheet 20.

To facilitate the extrusion of the resin material through the slot 24 between two adjacent plates 25 or in the one plate 26, the slot 24, in an embodiment, may be in communication with a pressure source 27. The pressure source 27, in one embodiment, can be coupled to a chamber 28 within which the resin material may be located prior to extrusion through the slot 24. Alternatively, a hydraulic cylinder, for example, may be utilized so as to bear on the resin material and thereby forcing the resin material through the slot 24. In accordance with an embodiment, the chamber 28 or cylinder may be heated to a temperature below that at which the resin material starts to cross link. For example, for furfuryl alcohol, the threshold temperature is about 50° centigrade (C). However, the plates 25 can be independently heated to help cross link the resin material as rapidly as possible as it moves across the slot 24.

As the extruded sheet 20 of resin material exits through the slot 24, the sheet 20 of resin material may, in accordance with one embodiment, be subjected to additional heat to further promote evaporation of any solvents, and to substantially complete cross linking. This post heating, in an embodiment, can be accomplished by passing the extruded sheet 20 though a radiation heater having temperatures not exceeding about 300° C., and preferably below 200° C. The now substantially dried and substantially fully polymerized sheet 20 may have a thickness, at this stage, that can be less than that of the slot.

The extruding sheet 20 may next be subjected to a pyrolysis process whereby the sheet 20 may be exposed to a slow and gradual increase in heat, for instance, less than 1° C. per minute, in an inert atmosphere, such as Argon or Helium, free of oxygen, or in vacuum. In an embodiment, the temperature may be raised to at least between about 1000° C. and about 2000° C., and more preferably about 1500° C. to about 1700° C. This slow increase in temperature, in one embodiment, allows the catalyst in the extruding sheet 20 to act as a template to which carbon within the high-carbon-containing resin can attach. The attachment of carbon to the template particles and the subsequent attachment to the existing carbon on the template particles occurs in series, so as to lead to the growth of an array of substantially continuous nanotubes within the substantially continuous sheet 20. The result can be the formation of a composite material having a glassy carbon matrix reinforced by an array of “grown-in” continuous carbon nanotubes. In an embodiment, the process can generate a substantially aligned array nanotubes.

To the extent necessary, the activity of the catalyst particles (e.g., iron particles) may need to be augmented. In one embodiment of the invention, thiophene (C₄H₄S) or another sulfur containing compound, for example, may be added to the resin prior to or during pyrolysis to augment the activity of the catalyst particles. In addition, it may be desirable to add trace amount of, for instance, Nb, Mo, Cr, or a combination thereof to the resin prior to or during pyrolysis to refine the size of the catalyst particles, in order to control the size of the nanotubes being grown.

Moreover, if desired, the glassy carbon filament may be exposed to a final ramp temperature in excess of about 2500° C. to anneal the filament to remove any potential defects within the sheet 20.

It should be noted that during extrusion, any known means of applying a pressure can be used, including direct mechanical pressure, pneumatic pressure, or oil pressure. This pressure, in an embodiment, should be applied in such a manner, so as to cause a substantially uniform displacement such that the thickness of the sheet 20 is substantially uniform. In one embodiment, this can be done by the use of, for example, hydraulic proportional valves, which can obtain a reference to the position through such means as a capacitance probe, an LVDA, or an induction sensor etc.

Moreover, although carbon nanotubes are disclosed herein, the present process may be implemented in a manner which includes chemically modifying the carbon in whole or in part, or by replacing the carbon with, for instance, silicon, boron or nitrogen, so that nanotubes can be generated containing elements other than or in addition to carbon. For instance, the nanotubes may be silicon-carbon nanotubes, boron-carbon nanotubes, nitrogen-carbon nanotubes, or a combination thereof.

The in situ composite having a glassy carbon matrix reinforced by a “grown-in” array of carbon nanotubes created in accordance with the above process may have a wide variety of applications based not only on mechanical properties, but also on chemical and electrical properties. Unlike other types of fiber composites, this type of in situ composite, for instance, can be cast into complex three-dimensional shapes or structures, coated on a substrate, provided as a thin film, or extruded as a filamentous fiber, then subsequently pyrolyzed to form the desired structure or coating fiber. It should be noted that liquid viscosity would not be substantially changed, since the nanotubes are grown within the structure after polymerization, followed by pyrolyzation.

In addition, properties of the structure or extrusion formed from this in situ composite can be tailored by changing the catalyst concentration or material within the composite, sheet, or filament. For example, silicon may be added to the outer portions of a structure, so as to form an oxidation-resistant coating of silicon carbide upon pyrolyzation. These capabilities can lead to the creation of devices, such as heart valves or blood vessel stents, as well as components (i.e., parts) of a device, including medical and surgical device. These devices or components, in one embodiment, may be provided with nanotubes in the high strength area, since nanotubes are known to have relatively high strength, and pure glassy carbon matrix in areas subject to harsh chemical environments or in areas where biocompatibility can be important, since glassy carbon matrix can withstand such environments.

### Applications

The composite material (i.e., filament or sheet) generated from either of the processes above may be provided with more than about 5% carbon nanotubes by weight and may be utilized in a variety of applications.

As an example, biocompatible and implantable biomedical devices may be made using the composite materials set forth in the present invention. For instance, anchoring screws for use in ACL and PCL reconstruction and other orthopedic implants.

The processes illustrated above, along with the composite material generated therefrom, can be utilized for other applications or manufacturing of other devices. For example, the process may be used to form ballistic armor. In one embodiment, the ballistic armor may be formed by initially coupling or layering commercially available body armor textile fabric or textile made from carbon nanotubes, yarns created from the carbon nanotubes, or carbon nanotube webs or belts. Next, a catalyzed resin, as described above, may be used to coat or couple a plurality of body armor textile fabric sheets and hold the sheets together, so as to contribute to the strength of the armor, as well as help to minimize or prevent cracks in the armor. The coated sheets may be pyrolyzed to generate the end product.

Other applications may include: (1) molded high strength parts, such as combat helmets, motorcycle helmets, football helmets and the like, (2) aerospace parts being used for high temperature applications, such as leading edges for hypersonic use, rocket nozzles etc., (3) motor parts, such as brake pads and bearings, (4) sporting goods, such as rackets, golf clubs, bicycle frames, (5) parts for use at substantially high temperature, including thermal conductors, electrical conductors, structural lightweight panels, and coatings for graphite, so as to reduce cost, while maintaining a high strength wear resistant surface, (6) engraving plates made from glassy carbon that can be highly resistant to wear and corrosive properties of inks used in intaglio or other forms of printing, and (7) biocompatible implantable parts or components, such as heart valves and stents, graded so that the glassy carbon matrix comes substantially into contact with body fluids, while the nanotube portions can be located in center regions or core areas of the composite and in high stress areas.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

What is claimed is:

1. A composite material comprising:
a substantially continuous filament; and
at least one substantially continuous carbon nanotube extending within the filament along its length.

2. A composite material as set forth in claim 1, wherein the filament has a diameter in a range of from about 0.5 microns to about 500 microns.

3. A composite material as set forth in claim 1, wherein the filament has a diameter of less than about 10 microns.

4. A composite material as set forth in claim 1, wherein the filament has a diameter of less than about 2 microns.

5. A composite material as set forth in claim 1, wherein the filament includes a glassy carbon matrix extending substantially the length of the filament.

6. A composite material as set forth in claim 1, wherein the filament is made from a resin material having a glassy carbon precursor.

7. A composite material as set forth in claim 6, wherein the glassy carbon precursor includes one of RESOL resin, furfuryl alcohol, PVA, or other similar materials with a glassy carbon precursor.

8. A composite material as set forth in claim 1, wherein the filament is made from a resin material having a non-glassy carbon precursor, such as pitch.

9. A composite material as set forth in claim 1, wherein the nanotube in the filament exists in an amount ranging from about 1% by volume to about 70% by volume.

10. A composite material as set forth in claim 1, wherein the amount of nanotubes in the filament is about 50% by volume.

11. A composite material as set forth in claim 1, wherein the nanotube includes a catalyst at one of its ends.

12. A composite material as set forth in claim 11, wherein the catalyst includes one of ferrocene; iron nano-particles; iron pentacarbonyl; nano-particles of magnetic transition metals or a compound of magnetic transition metals; noble metals; ceramic and intermetallic particles; fullerenes; small portions of carbon nanotubes; or a combination of any of these.

13. A composite material as set forth in claim 12, wherein the magnetic transition metals include one of iron, cobalt, cobalt hexacarbonyl, nickel, nickel hexacarbonyl, molybdenum, or their alloys, or oxides, nitrates or chlorides of these metals, or any combination of the oxides or other reducible salts, or organometallic compounds of these metals.

14. A composite material as set forth in claim 12, wherein the noble metals include gold particles having a diameter in a range of from about 1 nm to about 10 nm.

15. A composite material as set forth in claim 12, wherein the fullerenes include C₆₀.

16. A composite material as set forth in claim 11, wherein the catalyst includes a mixture of fullerene, ferrocene, and thiopene.

17. A composite material comprising:
a substantially continuous sheet; and
an array of substantially continuous carbon nanotubes extending within the sheet along its length.

18. A composite material as set forth in claim 17, wherein the sheet has a thickness in a range of from about 0.5 microns to about 500 microns.

18. A composite material as set forth in claim 17, wherein the sheet has a thickness of less than about 10 microns.

20. A composite material as set forth in claim 17, wherein the sheet has a thickness of less than about 2 microns.

21. A composite material as set forth in claim 17, wherein the sheet includes a film of a glassy carbon matrix extending substantially the length of the sheet.

22. A composite material as set forth in claim 17, wherein the filament is made from a resin material having a glassy carbon precursor.

23. A composite material as set forth in claim 22, wherein the glassy carbon precursor includes one of RESOL resin, furfuryl alcohol, PVA, or other similar glassy carbon precursor materials.

24. A composite material as set forth in claim 17, wherein the sheet is made from a resin material having a non-glassy carbon precursor, such as pitch.

25. A composite material as set forth in claim 17, wherein the array of nanotubes in the sheet exists in an amount ranging from about 1% by volume to about 70% by volume.

26. A composite material as set forth in claim 17, wherein the array of nanotubes in the sheet is about 50% by volume.

27. A composite material as set forth in claim 17, wherein each nanotube includes a catalyst at one of its ends.

28. A composite material as set forth in claim 27, wherein the catalyst includes one of ferrocene; iron nano-particles; iron pentacarbonyl; nano-particles of magnetic transition metals or a compound of magnetic transition metals; noble metals; ceramic and intermetallic particles; fullerenes; small portions of carbon nanotubes; or a combination of any of these.

29. A composite material as set forth in claim 28, wherein the magnetic transition metals include one of iron, cobalt, cobalt hexacarbonyl, nickel, nickel hexacarbonyl, molybdenum, or their alloys, or oxides, nitrates or chlorides of these metals, or any combination of the oxides or other reducible salts, or organometallic compounds of these metals.

30. A composite material as set forth in claim 28, wherein the noble metals include gold particles having a diameter in a range of from about 1 nm to about 10 nm.

31. A composite material as set forth in claim 28, wherein the fullerenes include C₆₀.

32. A composite material as set forth in claim 27, wherein the catalyst includes a mixture of fullerene, ferrocene, and thiophene.

33. A method of manufacturing a composite material, the method comprising:
extruding a resin material having a glassy carbon precursor and a catalyst through an aperture;
exposing the resin material as it is being extruded to a first elevated temperature range, so as to polymerize the resin material;
subjecting the polymerized resin material to a second elevated temperature range, so as to promote growth of at least one carbon nanotube from the catalyst and to transform the resin material into a reinforced composite material.

34. A method as set forth in claim 33, wherein the step of extruding includes heating the aperture to a temperature to promote initial polymerization of the resin material as it passes therethrough.

35. A method as set forth in claim 33, wherein the step of extruding includes coupling the aperture to a pressurized source to permit the subsequent extrusion to be performed under pressure.

36. A method as set forth in claim 33, wherein, in the step of extruding, the aperture approximates a geometric shape that provides the extruded resin material with a filamentous shape.

37. A method as set forth in claim 33, wherein, in the step of extruding, the aperture approximates a geometric shape that provides the extruded resin material with a shape of a sheet.

38. A method as set forth in claim 33, wherein the step of extruding includes heating the resin material to a temperature below that at which the resin material can start to polymerize.

39. A method as set forth in claim 33, wherein, in the step of extruding, the glassy carbon precursor includes one of RESOL resin, furfuryl alcohol, PVA, or other similar glassy carbon precursor materials.

40. A method as set forth in claim 33, wherein, in the step of extruding, the catalyst includes one of ferrocene; iron nano-particles; iron pentacarbonyl; nano-particles of magnetic transition metals or a compound of magnetic transition metals; noble metals; ceramic and intermetallic particles; fullerenes; small portions of carbon nanotubes; or a combination of any of these.

39. A method as set forth in claim 31, wherein the step of exposing includes substantially completing the polymerization of the resin material.

41. A method as set forth in claim 33, wherein, in the step of exposing, the first temperature range is about 300° C. or less.

42. A method as set forth in claim 33, wherein, in the step of subjecting, the second temperature range is from about 1000° C. to about 2000° C.

43. A method as set forth in claim 33, wherein the step of subjecting occurs in an inert atmosphere.
